(19) United States
(12) Patent Application Publication
(10) Pub. No.: US 2009/0210890 A1
(43) Pub. Date: Aug. 20, 2009

(54) REAL-TIME DATA COLLECTION VIA HIERARCHICAL WEB PAGE PARSING

(75) Inventor: Timothy Michael Tully, Fremont, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/032,381

(22) Filed: Feb. 15, 2008

(51) Int. Cl. G06F 3/00

(52) U.S. Cl. 719/331

(57) ABSTRACT

Methods and systems for instrumenting a web page to collect information on user actions associated with the web page and any of the elements contained therein are provided. For an element contained in the web page for which user actions are to be instrumented, include a single piece of instrumentation code in the source code of the web page, such that the piece of instrumentation code references the element with a unique element ID. Upon execution of the piece of instrumentation code, a hierarchical data structure representing the web page and the elements contained therein is parsed to determine any additional element(s) contained in the element. Information on one or more user actions associated with the element and the additional element(s) contained therein are transmitted. The piece of instrumentation code may invoke one or more library functions to perform various operations related to the collection of user action information.

### BACKGROUND OF THE INVENTION

The present invention relates to methods, apparatus, and computer program products for instrumentation web pages to collect information on user actions associated with a web page, and more specifically, for instrumentation web pages to collect information on various types of user actions, e.g., page view, link view, link click, etc., associated with an element contained in the web page, where the element may further contain one or more elements.

In the field of computer software programming, it is often important for software developers and researchers to measure and understand the dynamic behavior of a program. The same is true for many other fields as well, where dynamic information and/or data need to be collected for research and analysis purposes. For example, in the field of marketing and advertising, dynamic product information, especially information relating to the sales of the products, may be especially valuable in helping marketers and advertisers plan marketing and advertising strategies. Consequently, various types of statistical data are collected, stored, and subsequently analyzed and relied upon to increase the effectiveness of marketing and advertising efforts.

Dynamic behavior information of a computer program can only be collected during the execution of the program. Similarly, dynamic marketing and advertising information need to be collected in real-time or near real-time. One way to achieve this is through instrumentation, where additional code or statements, i.e., instruments, are inserted into software programs for data or information gathering purposes. The additional code is executed at the same time when the programs are running, but do not have any impact on the actual output of the programs. In other words, the sole purpose of the additional code is for collecting data or information in real-time or near real-time.

A common example of instrumentation is collecting information with respect to user actions associated with web pages. Often, website owners wish to know statistical information such as how many users view their web pages and how often. Such information may be collected via instrumentation by inserting additional code in the source of the web pages. The additional code does not alter the display of the web pages, but only collects the desired information. Thus, users do not see any difference in the web pages whether or not the instrumentation code is present. For example, a piece of instrumentation code written in some type of client-side script language may be inserted into the source of each web page, such that whenever a user requests a web page for viewing, a notification, often referred to as a beacon, is sent to a web server or a beacon server, indicating that the web page has been viewed by a user. Optionally, the beacon may also include information such as the identification of the user who has requested and viewed the web page, the time when the user views the web page, e.g., a timestamp, etc. The web server or beacon server collects and stores such notifications, and over time, the collected data may be analyzed to determine how often each of the web pages is viewed by the users, i.e., the page view count for each web page.

Of course, page view count is only one type of information in which website owners may have an interest. In practice, many different types of user actions associated with different parts of the web pages are of significant interest to the website owners. For example, it may be very useful to the website owners to determine which clickable links contained in the web pages are viewed and/or clicked by the users and how often. Often the website owners prefer to collect as detailed information relating to such user actions associated with their web pages as possible. At the same time, it would be cumbersome to have to insert a great amount of instrumentation code in the source of the web pages merely to collect some dynamic information. Therefore, it is preferable that web page instrumentation is done in a simple, easy, and straight-forward manner.

### SUMMARY OF THE INVENTION

Various embodiments of the present invention relates to systems and methods for instrumenting web pages to collect information on user actions associated with a web page and more specifically, for instrumenting web pages to collect information on user actions associated with an element contained in the web page based on a hierarchical data structure representing the web page and its elements.

According to one embodiment, a computer-implemented method of instrumenting a web page is provided. The method comprises the following steps: presenting the web page to a user associated with a client device, wherein the web page includes a first element with which the user can interact, the first element includes at least one additional elements with which the user can interact, and the web page includes a single piece of instrumentation code associated with the first element; and invoking a library function using the piece of instrumentation code, wherein the library function is configured to detect user actions relative to both the first element and the at least one additional element with reference to a hierarchical data structure representing the web page and relationships among the first element and the at least one additional element.

According to another embodiment, a computer-implemented method of instrumenting a web page is provided. The method comprises the following steps: transmitting the web page to a client device for presentation to a user, wherein the web page includes a first element with which the user can interact, the first element includes at least one additional elements with which the user can interact, and the web page includes a single piece of instrumentation code associated with the first element; executing a library function in response to execution of the piece of instrumentation code; detecting a user action relative to the at least one additional element with reference to a hierarchical data structure representing the web page and relationships among the first element and the at least one additional element; and generating a beacon signal representing the user action.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings in which like reference numerals refer to similar elements, and in which:

FIGS. 1A-1B illustrate portions of two sample web pages.

FIG. 2 illustrates a sample hierarchical data structure representing a web page and its elements.

FIG. 3 illustrates an example of a method of instrumenting a web page to collect information on user actions associated with an element contained in a web page.

FIG. 4 illustrates a sample server-client system for instrumenting a web page to collect information on user actions associated with an element contained in a web page.

FIG. 5 is a simplified diagram of a network environment in which specific embodiments of the present invention may be implemented.

### DETAILED DESCRIPTION OF THE INVENTION

The present invention will now be described in detail with reference to specific embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail to avoid unnecessarily obscuring the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

The content of a web page is often divided into different elements, and each element may be considered self-contained and may further contain one or more additional elements. An element may be a module, a section, an image, a paragraph, a table, a user-clickable link, etc. Each element may be identified by a unique ID. To detect and collect information on any user action associated with both an element and all the additional elements contained in that element, according to some embodiments, a piece of instrumentation code is included in the source code of the web page, referencing the element by its ID. The piece of instrumentation code may be executed on a client device, such as in a web browser after the web page is loaded into the browser. The code may be written in a client-side script language such as, for example, JavaScript or VBScript.

Upon execution of the piece of instrumentation code, a hierarchical data structure representing the web page, the elements contained in the web page, and relationships among the elements is parsed to identify the additional elements contained in the element being instrumented so that information on a user action associated with both the element and any of the additional elements contained in that element may be detected and collected automatically using the hierarchical data structure. A beacon signal representing the information on the user action associated with the element or any of the additional elements included in the element is transmitted. The user action may be, for example, viewing of the web page, viewing of the element and/or the additional elements included in the element, clicking of one of the additional elements, such as a link, included in the element. A database or a file system may be used to store the transmitted information on user actions.

For each element, a single piece of instrumentation code is included in the source code of the web page regardless of the number of additional elements contained in the element. The instrumentation code is responsible for causing the detection and information collection on any user action regardless of with which additional element contained in the element the user action is associated. Optionally, one or more library functions may be provided in connection with the piece of instrumentation code, and may be invoked when the piece of instrumentation code is executed. The library function(s) may implement the detection of the user actions, the collection of information on the user actions, and/or the parsing of the hierarchical data structure.

Alternatively, according to other embodiments, the detection and information collection of user actions associated with a web page and elements contained in the web page may be achieved at the server side. The server application may include code written in a server-side script language such as, for example, PHP. Such code may also reference the element being monitored with its ID and rely on a hierarchical data structure representing the web page, the elements contained in the web page, and relationships among the elements to identify any additional elements contained in the element. Again, information on a user action associated with both the element identified in the code by its ID and any of the additional elements contained in that element may be detected and collected automatically. However, in this case, since the detection and information collection are performed on the server, information on the user action associated with the element or any of the additional elements included in the element may be directly saved in a database connected with the server or a file on the server. There is no need to transmit any beacon signals.

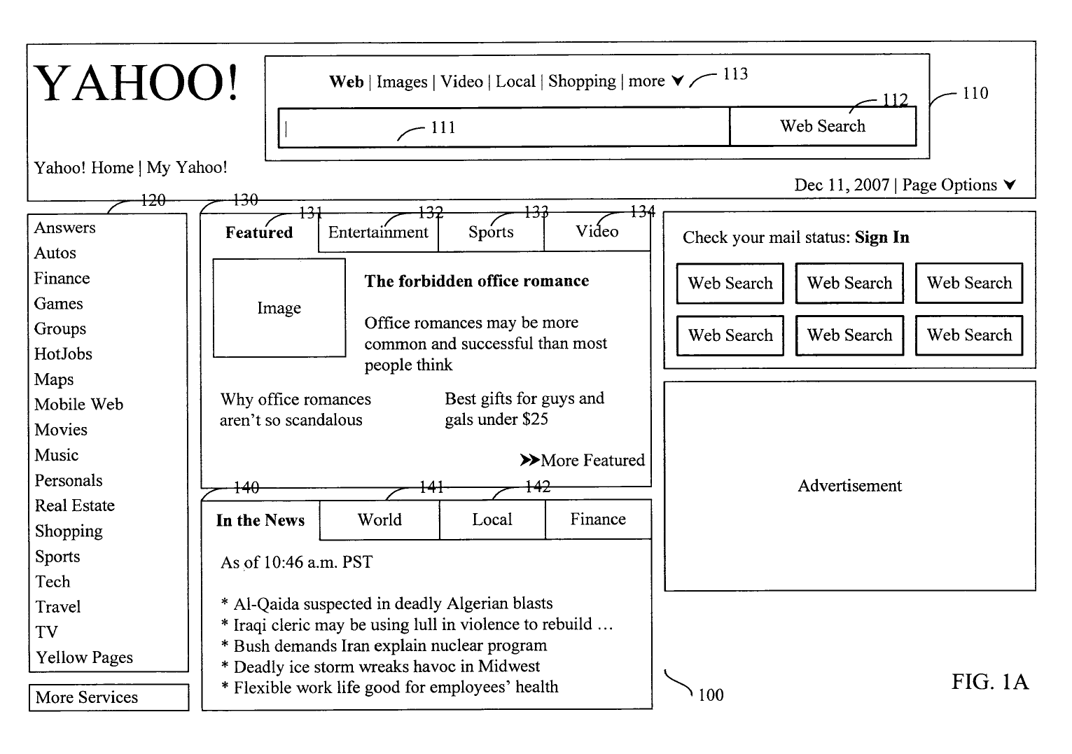

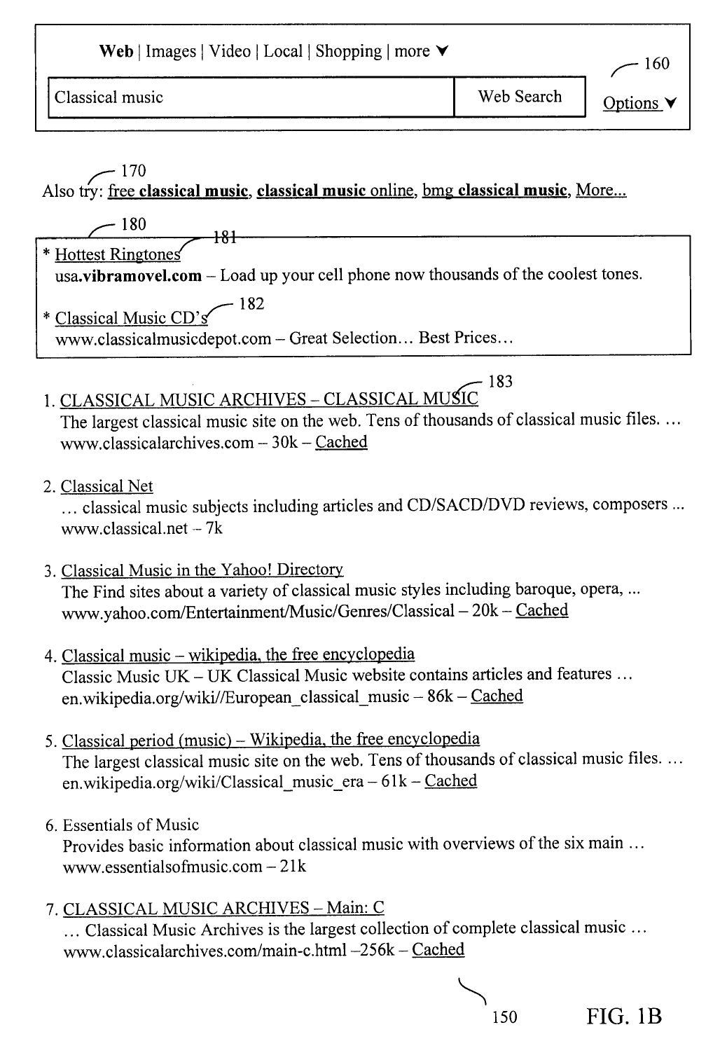

Web pages have become increasingly sophisticated and complicated. Many web pages are generated dynamically, i.e., upon requests by the users, so that different content may be displayed in the same web page at different times. FIG. 1A illustrates a portion of a sample web page 100. The web page 100 is divided into multiple modules 110, 120, 130, 140, where each module is relatively self-contained. For example, near the top of the web page 100 is a module 110 for the search engine. Module 110 includes a text field 111 where a user may enter a search term, and a button 112 for the user to initiate the search. Furthermore, the user may select a search base 113, such as searching the web, searching among images, searching videos, searching shopping sites, etc., by clicking on the appropriate tab for the sub-category. Thus, module 110 further contains several objects 111, 112, and 113 of various types.

Similarly, on the left of the web page 100 is a module 120 for the category indices. Module 120 includes clickable links to various categories such as “Answers”, “Autos”, “Finance”, etc. Each link may be considered an object contained in module 120. To be directed to a particular category, the user simply clicks on the appropriate link. In the middle of the web page 100 are two modules 130 and 140 relating to the news. Module 130 focuses on subject matter areas such as entertainment 132, sports 133, video 134, etc., whereas module 140 focuses on world news 141, local news 142, etc. Again, each tab or link may be considered an object contained in the respective module, and the users may click on specific tabs or links to view more detailed information.

Some of the objects in the web page 100 are relatively static, i.e., the same objects being displayed every time the page is generated. For example, the same text field 111, button 112, and search base 113 are displayed in module 110 or the same category indices are displayed in module 120. Other objects are more dynamic and change from time to time as the page is generated. For example, the featured stories 131 may be changed every time the web page 100 is generated, whereas the news content 141 and 142 may be changed several times a day.

If a user enters a search term in the text field 111 and clicks the button 112 to initiate a search, he or she will be directed to another page that contains the results of his or her search. FIG. 1B illustrates a portion of a search result page 150 generated for the search term “classical music”. Again, web page 150 is divided into multiple modules 160, 170, and 180. The main module 180 lists multiple links 181, 182, 183 to web pages relating to the subject matter of “classical music”, and each link 181, 182, 183 may be considered an item contained in module 180.

An element is a generic term that refers to any object in a web page for which user actions are associated with and to be detected. Each element may further contain one or more additional elements, but it is not always necessary for an element to further contain additional elements. Thus, an element can be an object on any level of the hierarchy associated with the web page. For example, suppose in a web page, a section contains a table, which in turn contains a paragraph. Here, the section, the table, and the paragraph are each an element of the web page and each may be identified by a unique element ID. Similarly, in the sample web pages 100 and 150 shown in FIGS. 1A and 1B, each module is an element, each tab is an element, each paragraph is an element, each link is an element, and so on.

An element may take a variety of forms such as, for example, a section (denoted by the HTML tag <div>), a form (denoted by the <form> tag), a frame (denoted by the <frame> or <iframe> tag), a paragraph (denoted by the <p> tag), an image (denoted by the <img> tag), a table (denoted by the <table> tag), a link (denoted by the <link> tag), an anchor (denoted by the <a> tag), etc.

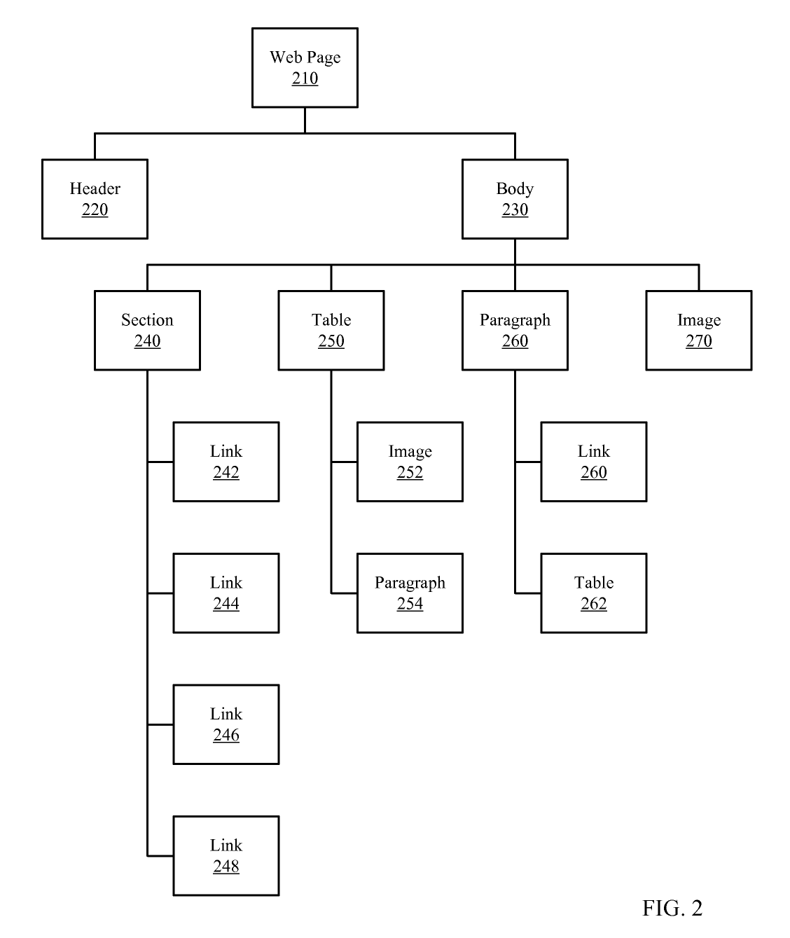

Web pages divided into modules, such as web pages 100 and 150, may be represented using a hierarchical data structure, e.g., DOM (Document Object Model). FIG. 2 illustrates a sample hierarchical data structure representing a web page and its elements. In this example, web page 210 contains a header 220 and a body 230. The header 220 is an element and the body 230 is another element. The body 230 contains four additional elements: section 240, table 250, paragraph 260, and image 270. Section 240 again contains four additional elements: link 242, link 244, link 246, and link 248. Table 250 contains two additional elements: image 252 and paragraph 254. Paragraph 260 also contains two additional elements: link 260 and table 262. Image 270 does not contain any additional element.

Each element, regardless of its actual type, contained in a web page may be identified by a unique ID. The relationships among the elements may be determined by parsing through the data structure representing the web page and its elements. In other words, by traversing the data structure, it may be determined which element contains which other additional element(s). This hierarchical data structure may be used to help automatically collect information on user actions associated with an element and any of the additional elements contained in the element once the higher-level element is identified.

It may be desirable to collect user action information associated not only with the web pages, but with individual elements contained in each of the web pages as well. It would be more desirable if such information may be collected in real-time or near real-time with minimum effort. One way to achieve this is through program instrumentation. According to various embodiments, a piece of instrumentation code is inserted in the source of a web page in connection with each element for which user action information is to be collected. The code references the element by its unique ID. The code is executed when the web page is requested by a user, and any user actions associated with the element and/or any of the additional elements contained in the element down to its lowest level may be automatically beaconed.

To simplify the process, a single piece of instrumentation code is included in the source code of the web page for each element. The same piece of instrumentation code is responsible for causing a beacon signal representing user actions associated with both the element and any additional element contained in the element to be transmitted, thus avoiding having to insert multiple pieces of instrumentation code, such as one for each specific element. In other words, the instrumentation code only needs to reference a higher-level element and thereafter, all of the additional elements contained in the higher-level element are instrumented automatically by referring to a hierarchical data structure.

There are different ways to handle the piece of instrumentation code. According to some embodiments, one or more library functions may be implemented. The library function may be a part of a programming library stored on a server and may be sent to a client to be executed in a web browser when invoked. When the piece of instrumentation code is executed, it invokes the library function(s). The library function(s) are responsible for determining which user action has occurred and with which element the user action is associated. The library function(s) are also responsible for transmitting a beacon signal that contains the information on the user action to a server where the information may be stored and subsequently analyzed. Thus, the same library function(s) may be repeatedly used in connection with many web pages and sent to may different clients, i.e., the pieces of instrumentation code in multiple web pages invoking the same library function(s).

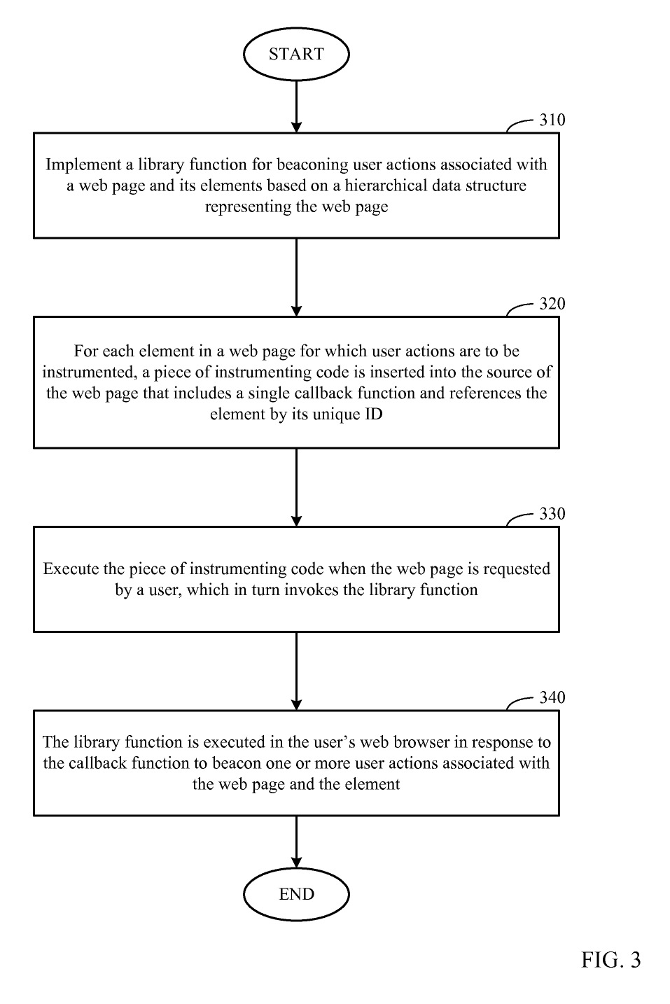

FIG. 3 illustrates an example of a method of instrumenting an element contained in a web page to detect user actions. As a preparation, one or more library functions are implemented for beaconing user actions associated with a web page and its elements (step 310). The library function(s) provides a program interface with which it may be invoked when needed. The actual definition of the program interface may vary depending on the specific implementations of the different systems. For example, the program interface may take as input parameters an element ID referencing the element to be instrumented and/or the type of instrumentation to be performed, i.e. the type of information to be collected. In addition, the library function(s) may be implemented using a suitable script language that may be executed in a web browser, such as JavaScript or VBScript.

The library function(s) have access to the hierarchical data structure representing any web page and its elements, since the library function(s) are a part of the server programming libraries. By parsing such data structure, the library function(s) may determine which additional element(s) is/are included in the element to be instrumented, i.e., the element referenced by the element ID. The library function(s) may take advantage of other existing code for parsing the data structure, if such code exists. For example, DOM (Document Object Model) is a platform-neutral and language-neutral interface that allows programs and scripts to dynamically access and update the content, structure, and style of documents. DOM is frequently used to represent the structures of web pages, and there exists a comprehensive set of DOM library functions for performing various operations, including parsing, on documents, such as web pages. Thus, if the web server employs DOM for its web pages, as is often the case, the library function(s) may use existing DOM libraries to perform some or all of the hierarchical data structure related operations.

Once the library function(s) have determined the element and all of its additional elements, any user action associated with the element or any of its additional elements may be beaconed when needed. For example, a user action may be viewing of a web page when the page is loaded in the user's web browser, viewing of a particular element in the web page, clicking of a link, movement of a mouse by the user, etc.

Subsequently, for each element in a web page for which user actions are to be instrumented a piece of instrumentation code is inserted into the source of the web page (step 320). The instrumentation code is responsible for invoking the appropriate library function(s) described in step 310. The element for which user actions are to be instrumented is identified by its element ID.

Note that it is no longer necessary to insert instrumentation code for each individual element. Instead, once a piece of instrumentation code is inserted for a particular element in the web page, user actions associated with any additional element included in the identified element may be instrumented automatically by referring to a hierarchical data structure.

After the instrumentation code is put in place, each time the web page is requested by a user, the instrumentation code is executed (step 330). The instrumentation code invokes the appropriate library function(s) via the programming interface. The library function(s) are executed in the web browser and are responsible for parsing the hierarchical data structure and beaconing the corresponding user action(s) to a server as a result (step 340). Information relating to the element and the corresponding user action may be sent to a beacon server, which collects and stores such data for further analysis.

It may be helpful to further explain steps 320, 330, and 340 using a specific example. Suppose it is desirable to collect information on user actions associated with module 120 of web page 100 shown in FIG. 1A, and particularly information on which category is selected by the users and how often. Program instrumentation may be used to beacon user actions associated with each of the category links contained in module 120. In this case, module 120 may be implemented as a section, and the following sample piece of HTML code may be used to construct this module in a browser:

```
<div id=“trough-cols”>
<ul id=“trough-1”>
    <li><a href=“r/4d”>Answers</a></li>
    <li><a href=“r/2h”>Autos</a></li>
    <li><a href=“r/25”>Finance</a></li>
    <li><a href=“r/28”>Games</a></li>
    <li><a href=“r/2r”>Groups</a></li>
    <li><a href=“r/3o”>HotJobs</a></li>
    <li><a href=“r/24”>Maps</a></li>
    <li><a href=“r/3a”>Mobile Web</a></li>
    <li><a href=“r/2i”>Movies</a></li>
    <li><a href=“r/3m”>Music</a></li>
    <li><a href=“r/33”>Personals</a></li>
    <li><a href=“r/2p”>Real Estate</a></li>
    <li><a href=“r/2q”>Shopping</a></li>
    <li><a href=“r/26”>Sports</a></li>
    <li><a href=“r/4c”>Tech</a></li>
    <li><a href=“r/29”>Travel</a></li>
    <li><a href=“r/2j”>TV</a></li>
    <li><a href=“r/2k”>Yellow Pages</a></li>
</ul>
</div>
```

Module 120 has a unique ID “trough-cols”. To instrument module 120 to collect information on user actions associated with module 120 and the clickable links contained in module 120, the following sample instrumentation code, written in JavaScript, may be inserted in the source of the web page:

```
<script>
    var conf = {tracked_mods[‘trough-cols’]};
    var ins = new SERVER.i13n.Track(conf);
    ins.init( );
</script>
```

Or more simply:

```
<script>
    (new SERVER.i13n.Track({tracked_mods[‘trough-
      cols’]})).init( );
</script>
```

Note that the two pieces of code achieve the same result.

In the above instrumentation code, module 120 is identified by its ID “trough-cols” as a value for the “tracked_mods” parameter. “SERVER.i13n.Track” is a class that is a part of a programming library. The instrumentation code first constructs a new instance of the SERVER.i13n.Track class, and then a method within the class, “init ( ),” is called on the constructed instance of the class. The method “init ( )” contains code that is responsible for detecting and collecting information on user actions and beaconing the information to the server.

Additional input parameters, such as a standard set of keys, may be included to be passed to the library function(s) for instrumentation. The following sample code sets a web page key for the name of the web page to be tracked:

```
<script>
    var page_keys = {pn:’my page name’, id:’my test
      id’};
    (new SERVER.i13n.Track({keys:page_keys,
      tracked_mods[‘trough-cols’]})).init( );
</script>
```

Here, the page key for the page name is “pn”, and the value is set to “my page name”. The page name key is passed to the current instance of the “SERVER.i13n.Track” class during its construction as one of the parameters.

The library function, upon construction and/or invocation, parses the hierarchical data structure representing the web page 100 to determine that module 120 (identified by the ID “trough-cols”) contains eighteen clickable links, i.e., eighteen categories. Upon an occurrence of a user action with respect to either module 120 or any one of the eighteen links contained therein, a beacon may be sent to a beacon server, indicating the appropriate user action that has occurred. For example, when web page 100 is loaded in the browser, a beacon may be sent to indicate that module 120 and all the links contained therein have been viewed by a user. The beaconed information regarding all the links contained in module 120 being viewed by a user may be referred to as “link view” information. When a user clicks on a particular category link, e.g., “Finance”, a beacon may be sent to indicate that a link click action has occurred with respect to the “Finance” link. This beaconed information may be referred to as “link click” information. When a user moves his or her mouse over the browser window, a beacon may be sent to indicate that a mouse movement has occurred, which may suggest that that there is really a user initiating those actions associated with the web page 100 and its modules, instead of done through automated programs.

The sample instrumentation code above is written in JavaScript, which is a client-side script language. In this case, the instrumentation code is executed on the client-side, e.g., in a web browser, such as when the web page is loaded in the browser after the server sends the web page source including the instrumentation code to the client in response to a request. Similarly, the library function(s) responsible for instrumenting the user actions are also executed in the browser. Other types of client-side script languages, e.g., VBScript, may also be used for writing the instrumentation code.

In alternative embodiments, collection of information on user actions may also be performed on the server. In this case, one or more library functions may be implemented using a server-side script language, such as PHP, Perl, server-side VBScript, etc. The code is responsible for monitoring the web pages transmitted to the clients. For example, each time a web page is sent to a client, the code examines the links contained in that web page and logs link view with respect to these links in a log file or a database. When a client requests a web page, the server generates and optionally buffers the source code for the web page to be sent to the client. The server may execute the library function code before sending the source code to the client.

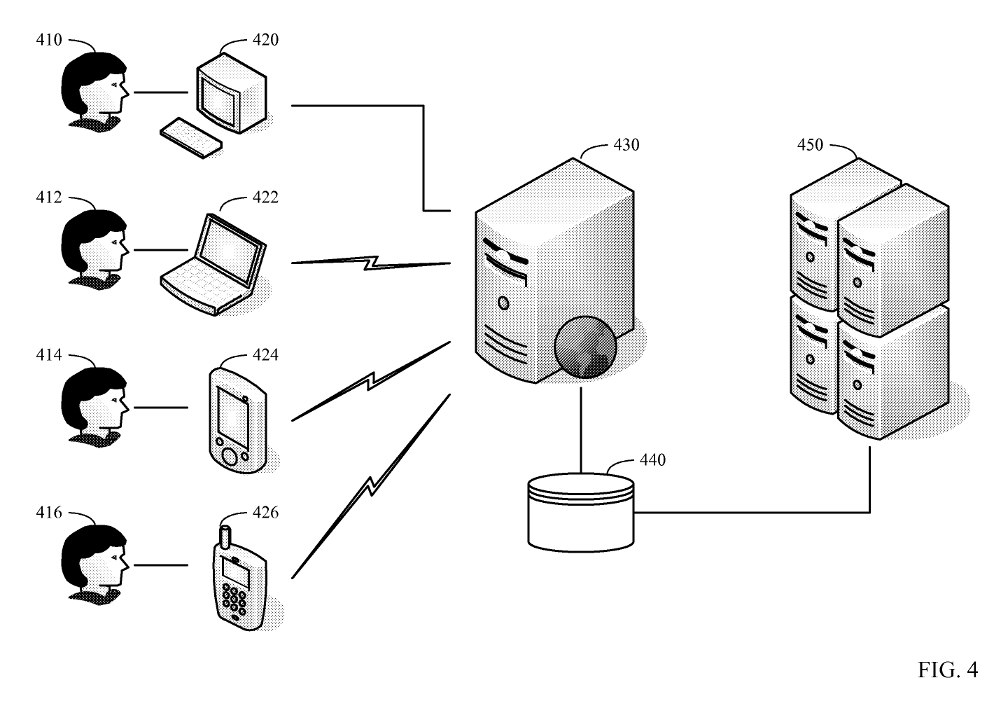

FIG. 4 illustrates a sample server-client system for instrumenting an element contained in a web page to detect user actions. Server 430 may be a web server and/or a beacon server. That is, it may be responsible for both hosting the web pages and receiving beaconed user actions. A beacon may be a simple HTTP (Hypertext Transfer Protocol) request for an image, but the URL (Uniform Resource Locator) of that request contains information on the user action being beaconed. Alternatively, these functions may be performed by different devices. In this particular embodiment, the library functions implementing the various tracking, instrumenting, and beaconing operations are included in a programming library on server 430. When these library functions are invoked, they are sent to the client devices 420, 422, 424, 426 to be executed in clients' web browsers. A database 440 may be communicatively connected with the server 430. Information relating to user actions may be stored in the database 440 when it is beaconed.

Various users 410, 412, 414, 416 may access the web server via different client devices, such as a desktop computer 420, a notebook computer 422, a PDA (Personal Digital Assistant) 424, or a smart phone 426. The connections may be wired or wireless. For example, when user 410 wishes to view a particular web page, the browser running on the computer 420 sends a request to the server 430 with the web page's URL (Uniform Resource Locator). The server generates the web page and sends the web page's source code to the browser on the computer 420 so that the browser may display the web page for the user 410.

The actions taken by the user 420 in connection with the web page, such as viewing the page (page view), viewing one or its modules or elements (element view or link view), clicking on one of the links contained in the web page (click), are beaconed to the server 430 and the beaconed data is stored in the database 440.

Once the user action information has been collected and stored in the database 440, it may be analyzed for different purposes. For example, the collected data may go through an ETL (Extract, Transform, Load) process to satisfy some business needs. The ETL process may be performed on the server 450, and the server 450 may access the database 440 directly or via the server 430 to obtain the previously collected and stored user action information.

As may be seen from the above description, the present invention has several advantages. For example, with the present invention, any user action associated with a web page or any of its contained element may be instrumented in real-time or near real-time. Not only the viewing of a web page, but the viewing of individual elements or the clicking of a specific element may be beaconed at it occurs. In addition, by taking advantage of a hierarchical data structure representing the web page, the library function may automatically determine the relationships between various elements, and more specifically, which element contains which other elements. Thus, it is no longer necessary to insert a piece of instrumentation code for each individual element. Instead, only a single piece of instrumentation code is needed for each module, and all elements contained within that module are automatically monitored or tracked. This greatly simplifies the instrumenting process. The instrumentation code is executed on the client-side, giving the website owners greater flexibility.

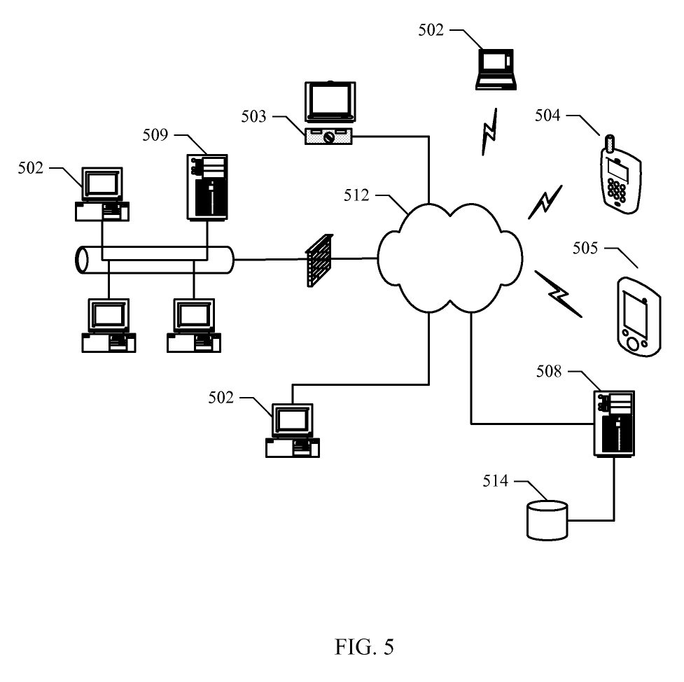

FIG. 5 is a simplified diagram of a network environment in which specific embodiments of the present invention may be implemented. It will be understood that computer software programs implementing various aspects of the invention may be executed in such an environment.

The various aspects of the invention may be practiced in a wide variety of network environments (represented by network 512) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations. All or a portion of the software program implementing various embodiments may be executed on the server 508.

The client devices 502, 503, 504, 505 and the servers 508, 509 may communicate with each other via the network 512. User action information may also be beaconed to the appropriate beacon servers, e.g., server 508, via the network 512. One or more database, e.g., database 514, may be used to store the beaconed information.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method of instrumenting a web page, comprising:
presenting the web page to a user associated with a client device, wherein the web page includes a first element with which the user can interact, the first element includes at least one additional elements with which the user can interact, and the web page includes a single piece of instrumentation code associated with the first element; and
invoking a library function using the piece of instrumentation code, wherein the library function is configured to detect user actions relative to both the first element and the at least one additional element with reference to a hierarchical data structure representing the web page and relationships among the first element and the at least one additional element.

2. The computer-implemented method, as recited in claim 1, further comprising:
receiving code for the library function from a server; and
executing the library function on the client device.

3. The computer-implemented method, as recited in claim 1, wherein the piece of instrumentation code references the first element by an element ID.

4. The computer-implemented method, as recited in claim 3, wherein the element ID is sent to the library function by the piece of instrumentation code when the library function is invoked.

5. The computer-implemented method, as recited in claim 1, wherein the piece of instrumentation code is written in a client-side scripting language and executed on the client device.

6. The computer-implemented method, as recited in claim 1, wherein the user actions are at least one selected from a group consisting of viewing of the first element, viewing of the at least one additional element, clicking of the first element, clicking of one of the at least one second element, and moving of a mouse.

7. A computer-implemented method of instrumenting a web page, comprising:
transmitting the web page to a client device for presentation to a user, wherein the web page includes a first element with which the user can interact, the first element includes at least one additional elements with which the user can interact, and the web page includes a single piece of instrumentation code associated with the first element;
executing a library function in response to execution of the piece of instrumentation code;
detecting a user action relative to the at least one additional element with reference to a hierarchical data structure representing the web page and relationships among the first element and the at least one additional element; and
generating a beacon signal representing the user action.

8. The computer-implemented method, as recited in claim 7, wherein the first element is referenced to the library function by the piece of instrumentation code with an element ID when the library function is instantiated.

9. The computer-implemented method, as recited in claim 8, wherein detecting the user action relative to the at least one additional element comprises:
parsing the hierarchical data structure with reference to the element ID to identify the at least one additional element included in the first element.

10. The computer-implemented method, as recited in claim 7, further comprising:
transmitting the beacon signal to a server.

11. The computer-implemented method, as recited in claim 10, further comprising:
storing data contained in the beacon signal in a database.

12. The computer-implemented method, as recited in claim 7, further comprising:
sending code of the library function to the client-device.

13. The computer-implemented method, as recited in claim 7, wherein the piece of instrumentation code is written in a client-side scripting language and executed on the client device.

14. The computer-implemented method, as recited in claim 7, wherein the user action is one selected from a group consisting of viewing of the first element, viewing of the at least one additional element, clicking of the first element, clicking of one of the at least one second element, and moving of a mouse.

15. A computer program product for instrumenting a web page, comprising at least one computer-readable medium having a plurality of computer program instructions stored therein, which are configured to cause at least one computing device to:
transmit the web page to a client device for presentation to a user, wherein the web page includes a first element with which the user can interact, the first element includes at least one additional elements with which the user can interact, and the web page includes a single piece of instrumentation code associated with the first element;
execute a library function in response to execution of the piece of instrumentation code;
detect a user action relative to the at least one additional element with reference to a hierarchical data structure representing the web page and relationships among the first element and the at least one additional element;
generate a beacon signal representing the user action.

16. The computer program product, as recited in claim 15, wherein the first element is referenced to the library function by the piece of instrumentation code with an element ID when the library function is instantiated.

17. The computer program product, as recited in claim 16, wherein for detecting the user action relative to the at least one additional element, the plurality of computer program instructions are further configured to cause the at least one computing device to:
parse the hierarchical data structure with reference to the element ID to identify the at least one second element included in the first element.

18. The computer-implemented method, as recited in claim 15, wherein the user action is one selected from a group consisting of viewing of the first element, viewing of the at least one additional element, clicking of the first element, clicking of one of the at least one second element, and moving of a mouse.
